(19) United States
(12) Patent Application Publication
(10) Pub. No.: US 2008/0065495 A1
(43) Pub. Date: Mar. 13, 2008

(54) Consumer device used in commercial transactions

(76) Inventor: Martin Khang Nguyen, Westminster, CA (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/985,518

(22) Filed: Nov. 14, 2007

Related U.S. Application Data
(63) Continuation-in-part of application No. 09/931,677, filed on Aug. 15, 2001, now abandoned.
(63) Continuation-in-part of application No. 10/461,556, filed on Jun. 12, 2003, now abandoned.

(51) Int. Cl. G06Q 30/00

(52) U.S. Cl. 705/14

(57) ABSTRACT

An embodiment of the present invention includes a consumer device used in a transaction. An identifier represents a management entity. The management entity has an established relationship with at least one of a provider, a consumer, and a vendor. A medium encoded with an information section to contain information related a transaction conducted by the consumer at the provider. The transaction involves a product. The information corresponds to a discount for the product provided by at least one of the management entity, the provider, and the vendor. The information is retrieved at the provider via a device reader when the consumer purchases the product to receive the discount after the provider verifies the consumer. Another embodiment of the invention includes a technique to process a transaction. A management entity is verified from an identifier on a device presented by a consumer in a transaction involving a product. The management entity has an established relationship with at least one of a provider, the consumer, and a vendor. Information related to the transaction is retrieved from the device. The information corresponds to a discount for the product provided by at least one of the management entity, the provider, and the vendor. The consumer is verified. The discount for the product is provided after the consumer is verified.

### RELATED APPLICATIONS

This application is a continuation-in-part (CIP) of the following applications: (1) Ser. No. 09/931,677, titled “Discount Purchase Business Method”, filed Aug. 15, 2001, (2) Ser. No. 10/461,556, titled “Coupon Rebate Business Method Using Portable Personal Communication Devices”, filed Jun. 12, 2003.

### BACKGROUND

1. Field of the Invention

Embodiments of the invention relate to the field of commercial transactions, and more specifically to management of commercial transactions.

2. Description of the Related Art

Commercial transactions typically involve manufacturers, retailers, and consumer purchasers. In a typical commercial retail transaction, a consumer purchases a product or products of a manufacturer at a retailer. The product may be available at a discount. The discount may be provided by the manufacturer or the retailer. When there are a large number of transactions taking place, it is cumbersome for a retailer or a manufacturer to keep track of product discounts or promotional services to consumers.

Existing techniques to manage commercial retail transactions have a number of drawbacks. One technique involves the use of a system for the electronic management and redemption of coupons. The technique requires the use of a coupon card which contains a bar code scanner, a memory, a display screen, and a communication port. This technique requires complex circuitry embedded in the coupon card and may be too complex to use for an average consumer. Another technique processes rebate claims submitted by a consumer. The technique transfers the purchase data record from a point-of-sale (POS) to a fulfillment administrator. The fulfillment administrator credits the designated card used by the consumer. This technique does not provide the flexibility in communications among the consumer, the retailer, and the manufacturer.

### BRIEF DESCRIPTION OF THE DRAWINGS

Embodiments of invention may best be understood by referring to the following description and accompanying drawings that are used to illustrate embodiments of the invention. In the drawings:

FIG. 1 is a diagram illustrating a system according to one embodiment of the invention.

FIG. 2 is a diagram illustrating a device according to one embodiment of the invention.

FIG. 3 is a diagram illustrating a provider processing unit according to one embodiment of the invention.

FIG. 4 is a flowchart illustrating a process to create a device according to one embodiment of the invention.

FIG. 5A is a flowchart illustrating a process to process a transaction at the provider according to one embodiment of the invention.

FIG. 5B is a flowchart illustrating a process to verify the consumer at the provider according to one embodiment of the invention.

FIG. 6 is a flowchart illustrating a process to process a transaction at the management entity according to one embodiment of the invention.

FIG. 7 is a diagram illustrating a transaction management portal engine or a controller according to one embodiment of the invention.

### DESCRIPTION

Embodiments of the invention includes a consumer device used in a transaction. An identifier represents a management entity. The management entity has an established relationship with at least one of a provider, a consumer, and a vendor. A medium encoded with an information section to contain information related a transaction conducted by the consumer at the provider. The transaction involves a product. The information corresponds to a discount for the product provided by at least one of the management entity, the provider, and the vendor. The information is retrieved at the provider via a device reader when the consumer purchases the product to receive the discount after the provider verifies the consumer.

Another embodiment of the invention includes a technique to process a transaction. A management entity is verified from an identifier on a device presented by a consumer in a transaction involving a product. The management entity has an established relationship with at least one of a provider, the consumer, and a vendor. Information related to the transaction is retrieved from the device. The information corresponds to a discount for the product provided by at least one of the management entity, the provider, and the vendor. The consumer is verified. The discount for the product is provided after the consumer is verified.

In the following description, numerous specific details are set forth. However, it is understood that embodiments of the invention may be practiced without these specific details. In other instances, well-known circuits, structures, and techniques have not been shown in order not to obscure the understanding of this description.

One embodiment of the invention may be described as a process which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a program, a procedure, a method of manufacturing or fabrication, etc.

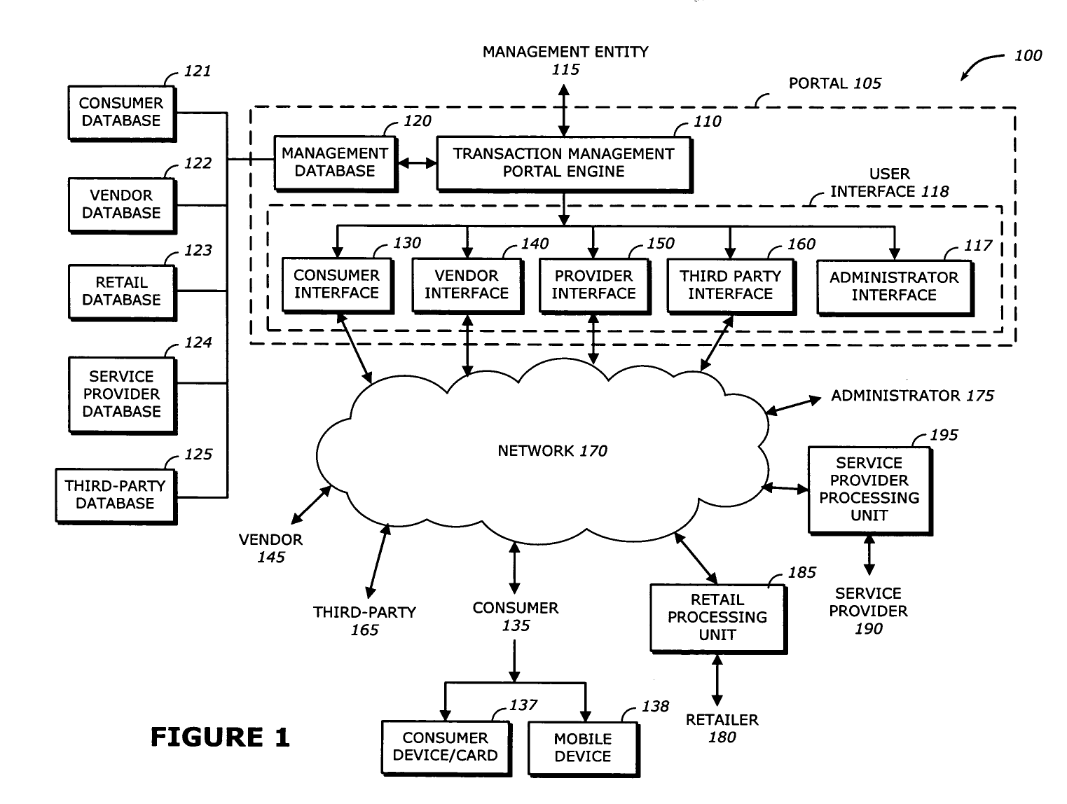

FIG. 1 is a diagram illustrating a system 100 according to one embodiment of the invention. The system 100 includes a portal 105, a network 170, a consumer 135, a vendor 145, a retailer 180, a service provider 190, a third-party entity 165, and an administrator 175. The system 100 may include more or less than the above components.

The portal 105 provides functionalities for a point of access on the Web. It provides a centralized management of commercial transactions that may involve various commercial entities or users such as consumers represented by the consumer 135, vendors and/or, manufacturers represented by the vendor 145, retailers represented by the retailer 180, service providers represented by the service provider 190, and third party entities (e.g., credit issuers, payment processing entities, advertisers) represented by the third-party entity 165. It includes a transaction management portal engine 110, a management database 120, and a user interface 118. The user interface 118 interfaces to a user performing a commercial transaction. The commercial transaction may be related to sale processing of a product or service. The user may be one of the consumer 135, the vendor 145, the retailer 180, the service provider 190, or the third-party entity 165. It includes a consumer interface 130, a vendor interface 140, a provider interface 150, and an administrator interface 117. The administrator interface 117 provides access to the portal 105 by the administrator 175. The administrator 175 is a person or an entity that is responsible for the administration of the portal 105. Most likely, the administrator 195 is an agent, an employee, a representative, or an official of the management entity 115.

The transaction management portal engine 110 is configured, set up, and operated by the management entity 115. It is part of the portal 105. It may manage the commercial transaction performed by the user using user information. The transaction management portal engine 110 may include a number of tools to configure, set up, and operate a portal. It may include a number of portlets customized for various users. It may include specialized processing subsystems or engines to process rules or obtain information related to the businesses involved in the sale processing of products or services administered by the portal 105

The management database 120 is a centralized database that integrates information provided by the commercial entities as part of the commercial management. The management database 120 may provide the user information related to the commercial transaction to the portal engine 110. It may include a consumer database 121, a vendor database 122, a retail database 123, a service provider database 124, and a third-party database 125.

In particular, the transaction management portal engine 110 provides interface to three main constituents of commercial entities: vendor, consumer, and provider. It may also have an interface to third-party entities. Each of the interfaces provides accessibility to the portal 105 by the commercial entities via the network 170.

The network 170 may be any suitable network such as the Internet or wireless network. Each of the participants may access the portal 105 via any suitable means including logging on to a computer with a Web browser, communicating via a wired or wireless network using a wireless device, such as a personal digital assistant (PDA), a cellular device, a portable computing device, a desktop personal computer (PC), a notebook PC, etc.

The commercial entities include the customer 135, the vendor 145, the third-party entity 165, the retailer 180, and the service provider 190. These entities are shown in singular form for brevity. It is understood that each entity may include a plurality of them. The consumer 135 is any consumer or an entity who purchases a product or receives a service. The consumer 135 communicates with the portal engine 110 via the consumer interface 130. The vendor 145 may be a seller, a manufacturer, a wholesaler, or any entity that creates, manufactures, or promotes a product. The vendor 145 communicates with the portal engine 110 via the vendor interface 140. The third-party entity 165 may be any entity that provides supplemental products or services to the transactions, such as sales representation, payment processing, advertisement, insurance brokerage, etc. The third-party entity 165 communicates with the portal engine 110 via the third-party interface 160. The retailer 180 may be any retailer to re-sell products provided by the vendor 145. For example, the retailer 180 may be a distributor, a wholesaler, a retail store, a supermarket, a grocery store, a shopping mall boutique, a department store, a restaurant, a movie theater, a hotel, etc. The service provider 190 may be any provider that provides a service to the consumer 135. For example, the service provider 190 may be a rental agency, a human resource agency, a professional (e.g., dentist, doctor, lawyer, accountant, real estate agent, engineer, financial advisor), etc. The retailer 180 and the service provider 190 communicate with the portal engine 110 via the appropriate components in the provider interface 150. The retailer 180 and the service provider 190 may be referred to as a provider.

The retailer 180 may have a retail processing unit 185 to process the transactions locally at the retailer's facility. The retail processing unit 185 may have connection to the network to communicate with the transaction management portal engine 110. Similarly, the service provider 190 may have a service provider processing unit 195 to process the transactions locally at the service provider's facility or office. The retail processing unit 185 or the service provider processing unit 195 may include a scanner or a reader to read or scan the consumer device 137. It may include a wireless receiver/transmitter to receive/transmit information from/to the mobile device 138.

The management entity 115 has an established relationship with at least one of the consumer 135, the vendor 145, the third-party entity 165, the retailer 180, and the service provider 190. The management entity 115 maintains all the relationships and provides the registered participants a centralized marketplace. Upon registration, each participant may receive a log-in name and/or password to allow the registered participant to access to the marketplace.

The consumer 135 may register with the management entity 115 to become a member in the consumer group managed by the management entity 115. Upon registration, the consumer 135 may provide personal information such as name, address, financial information (e.g., bank information, credit references). The information provided by the consumer 135 may be integrated into the management database 120. As a member, the consumer 135 may receive a number of benefits. The consumer 135 may receive a consumer device/card 137, a membership number, an authorization code, a discount code, or any unique identifier that identifies the consumer 135 as a registered participant with the mangement entity 115. The consumer device 137 may be a loyalty card, a saving card, a discount card, a membership card, a wallet card, or an identification card to allow the consumer 135 to provide verification information as a legitimate user of the discount or sales. The consumer device 137 may contain the information in barcode, magnetic strip, or in any form that can be read or scanned by a reader at the facility of the retailer 180 or the service provider 190. The consumer device 137 allows the consumer 135 to receive discounts or rebates on merchandises, products, or services offered by any other entities registered with the management entity 115. The consumer 135 may also access the consumer interface 130 to navigate through a variety of informational items such as announcements, advertisements, sales promotions, rebates or discounts, sweepstakes, lotteries, entitlements, cash-back offers, product catalogs, etc. The consumer 135 may perform an action on the informational items such as production selection, vendor and provider browsing and selection, discount or rebate redemption, on-line purchases, registration for receiving updates, newsletters, announcements, consumer card order, etc. The information provided by the consumer 135 may be integrated into the consumer database 121.

The consumer 135 may also have a mobile device 138 such as a cellular device (e.g., cell phone), a personal digital assistant (PDA), or any mobile device having a wireless receiver/transmitter. The wireless connection may be radio frequency (RF), optic, infrared, Bluetooth, or any other forms of wireless transmission. The membership number or authorization code may be stored in the mobile device 138. The mobile device 138 may be used by the consumer 135 to communicate the network 170, the retail processing unit 185, or the service provider processing unit 195 by transmitting the membership number or the authorization code. The mobile device 138 may have appropriate computing power including memory, input entry device (e.g., keyboard, trackball), display, etc. The mobile device 138 may also have appropriate operating system or programs to transmit a consumer card number, security information for verification, discount information, selected items, etc. to the network 170, the retail processing unit 185, or the service provider processing unit 195. The mobile device 138 may also have appropriate receiver circuitry to receive information downloaded from the portal 105. The downloaded information may include textual, graphical, or imaging information (e.g., rebate image) related to products or services supported by the portal 105.

The vendor 145 may register with the management entity 115 to become a member in the vendor group managed by the management entity 115. The vendor 145 may provide the management entity 115 a product catalog, price list, promotional information, etc to be stored in the vendor database 122. The vendor 145 may keep the information up-to-date by sending updates to the management entity 115. The information provided by the vendor 145 may be integrated into the vendor database 122. The information provided by the consumer 135 may be integrated into the consumer database 121.

The retailer 180 or the service provider 190 may register with the management entity 115 to become a member in the provider group managed by the management entity 115. The retailer 180 or the service provider 190 may provide the management entity 115 a product catalog, price list, promotional information, etc. The retailer 180 or the service provider 190 may keep the information up-to-date by sending updates to the management entity 115. The information provided by the retailer 180 or the service provider 190 may be integrated into the retail database 123 and service provider 124, respectively.

The third-party entity 165 may register with the management entity to become a member in the third-party group managed by the management entity 115. The third-party entity 165 may provide the management entity 115 a product catalog, price list, promotional information, etc. The third-party entity 165 may keep the information up-to-date by sending updates to the management entity 115. The information provided by the third-party entity 165 may be integrated into the third-party database 125.

The management entity 115 establishes a relationship with each of the consumer 135, the vendor 145, the retailer 180, the service provider 190, and the third-party entity 165 to provide a centralized management of commercial transactions. The consumer 135 is issued the consumer device 137 or a membership number to be entered in, and transmitted by, the mobile device 138 to receive discount on products or services purchased at the facility of the retailer 180 or the service provider 190. The management entity 115 may enter into contracts or agreements with the vendor 145, the retailer 180, the service provider 190, or the third-party entity 165 to publicize their products, services, or offers to a wide audience of consumers. In return, the management entity 115 may receive a fee or a payment. By providing a centralized database, the management entity 115 allows the consumer 135 to be able to browse through the product catalogs, promotional items, and other offers by the vendor 145, the retailer 180, the service provider 190, or the third-party entity 165 via the consumer interface 121. The vendor 145 or the third-party entity 165 may provide the management entity 115 the discount or rebate which can be passed onto the retailer 180 each time a transaction is made at the retailer 180. The retailer 180 may transmit the retail transactions to the management entity 115 via the provider interface 150 so that the management entity 115 may process the discount payment. The management entity 115 may also provide a discount or reward to the consumer 135.

The portal 105 acts as a centralized market place where the participants (e.g., the consumer 135, the vendor 145, the retailer 180) may perform many commercial transactions. The participants may create profiles, update their database, exchange information, post comments or messages, carry out real-time transactions, perform payments, etc.

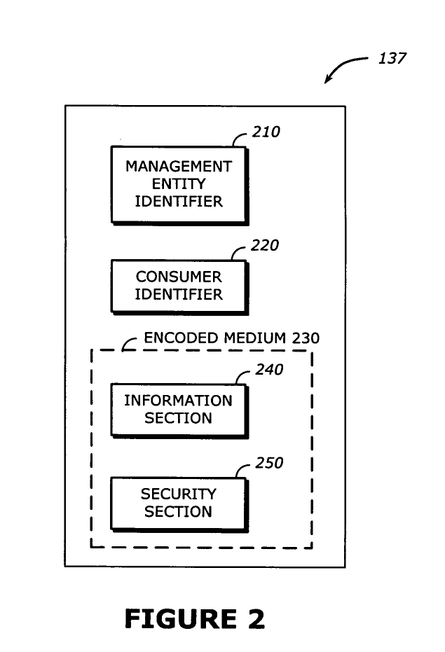

FIG. 2 is a diagram illustrating the device or the device 137 shown in FIG. 1 according to one embodiment of the invention. The device 137 includes a management entity identifier 210, a consumer identifier 220, and an encoded medium 230. The device 137 may include more or less than the above components.

The management entity identifier 210 represents a management entity (e.g., the management entity 115 shown in FIG. 1). The management entity has an established relationship with at least one of a provider, a consumer, and a vendor. The management entity identifier 210 may be an indicia, a label, a mark, a symbol, an encoded data, a logo, or any indicator that identifies or represents the management entity 115.

The management entity identifier 210 or its simile may be imprinted, marked, affixed, or tagged on a display item next to a product announcement to signify that the product or service is being managed by the management entity. The product announcement may be an advertisement distributed via any broadcast medium such as on the Internet, newspapers, television, etc. It may also be displayed on a billboard or an announcement display at a retailer or a service provider. Upon viewing the product/service announcement, the consumer 135, being a member of the consumer group managed by the management entity 115, recognizes the identifier and realizes that the associated product or service may be offered with a discount or rebate. The consumer 135 may confirm this association by logging on the portal 105 and identify the product and the provider(s) that offers the product or service. The consumer 135 may purchase the product or receive the service at the facility of the retailer 180 or the service provider 190. The consumer 135 may present the device 137 use the mobile device 138 or to transmit information to the retailer 180 or the service provider 190 at a check-out stand, a cashier, or a cashier window to receive the discount or rebate.

The consumer identifier 220 identifies the consumer 135. It may include a name of the consumer 135. It may also include other identification of the consumer 135 such as a membership number, an address, a photograph, or any other information that the retailer 180 or the service provider 190 may identify the consumer 135 as the legitimate device holder.

The encoded medium 230 may be a medium that is encoded with information related to the consumer 135. The medium may be any suitable medium that may be read or retrieved by a device reader, such as electronic, magnetic, electromagnetic, or optical. It may include an information section 240 and a security section 250. The information section 240 may contain information related a transaction conducted by the consumer 135 at the retailer 180 or the service provider 190. The transaction involves a product. The product may be a merchandise, a physical item, or a service. The information corresponds to a discount for the product. The discount may be provided by at least one of the management entity 115, the provider 180/190, and the vendor 145. The information may be retrieved at the provider 180/190 via a device reader when the consumer 135 purchases the product, or receives the service, to receive the discount after the provider 180/190 verifies the consumer 135.

The information may include at least one of personal identification information to identify the consumer, a value amount purchased by the consumer for a later discounted purchase, a fixed or variable discount level providing a privilege for a consumer action, and a combination of a credit or debit and a discount coupon. The advantage of using the consumer device 137 is to eliminate the use of paper coupons or any other cumbersome schemes to receive discounts or rebates.

The security section 250 may include an inquiry on security information related to the consumer 135. The security information may be used to prevent unauthorized use of the device 137. For example, the device 137 may be stolen or used by somebody else other than the registered consumer. The security information may include at least one of secret data and biometric information. The secret data may include an inquiry regarding at least one of a password, a secret question, a security code, and a personal identification number (PIN). The biometric information may include fingerprint, iris scan, or any biological information unique to the consumer 135. The secret data or the biometric information may be used to verify the consumer. When the device 137 is scanned at the retailer 180 or the service provider 190, the consumer 135 may be asked to enter one of the secret data such as the password or the PIN, or the biometric information. The scanner may have a display that displays the inquiry to request the secret information. When the consumer 135 enters the response, the response may be checked locally at the retailer 180 or the service provider 190 or transmitted to the management 115 for verification. After the consumer is verified, the transaction may proceed. For example, a discount for the product or service may be provided. The inquiry may be randomly generated from a number of possible security questions so that an observer may not predict what the next inquiry is. The randomness may be based on a random generator built-in the scanner or on other dynamic data such as time of day, etc. At one time, the inquiry may be a request to enter a password. At another time, the inquiry may be a request to answer a secret question (e.g., name of high school, mother's maiden name).

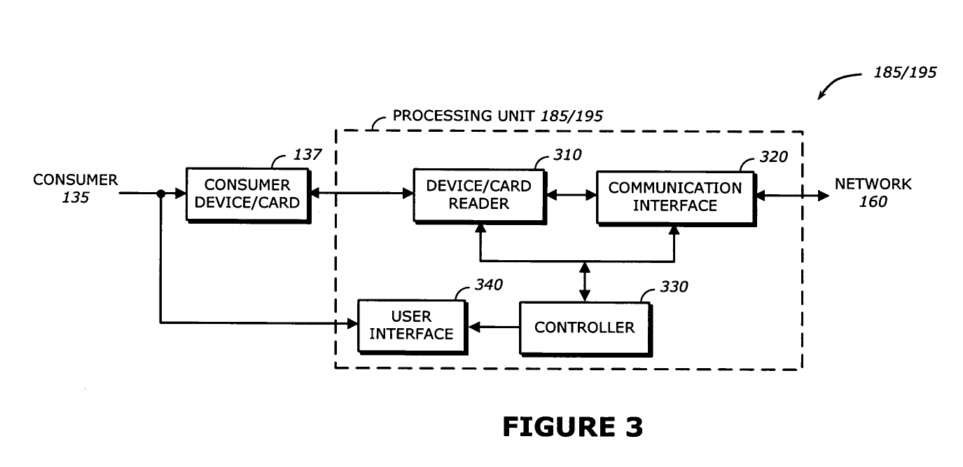

FIG. 3 is a diagram illustrating the provider processing unit 185/195 shown in FIG. 1 according to one embodiment of the invention. The provider processing unit 185/195 includes a device or device reader 310, a communication interface 320, a controller 330, and a user interface 340. The provider processing unit 185/195 may include more or less than the above components.

The device reader 210 reads the device 137 presented by the consumer 135 in a transaction involving a product at a provider (e.g., the retailer 180 or the service provider 190). The device 137 contains an identifier to represent the management entity 115 and information related to the transaction. The management entity 115 has an established relationship with at least one of the provider 180/190, the consumer 135, and the vendor 145 of the product. The information corresponds to a discount for the product. The discount may be provided by at least one of the management entity 115, the provider 180/190, and the vendor 145. The device reader 210 may also read a security section containing an inquiry on security information regarding the consumer as discussed above. The inquiry may be one of a number of possible inquiries. The inquiry may be selected at random and presented to the consumer 135 at the time the device is presented. The consumer 135 may be requested to enter a response to the inquiry.

The communication interface 220 is coupled to the device reader 120 to transmit the information to the management entity 115 and receive discount information on the transaction from the management entity 115. The discount information is used to give the discount to the consumer 135 after the consumer 135 is verified.

The controller 330 may be a programmable processor that controls the device reader 310, the communication interface 320, and the user interface 340. It may include memory and other peripheral components. It may include a random generator to select an inquiry at random from a number of inquiries encoded in the security section of the device 137.

The user interface 340 may include a display unit that displays the inquiry on the security question and an input unit such as a keypad or a biometric scanner to allow the consumer 135 to enter the response to the security inquiry or deposit the biometric information such as the fingerprint.

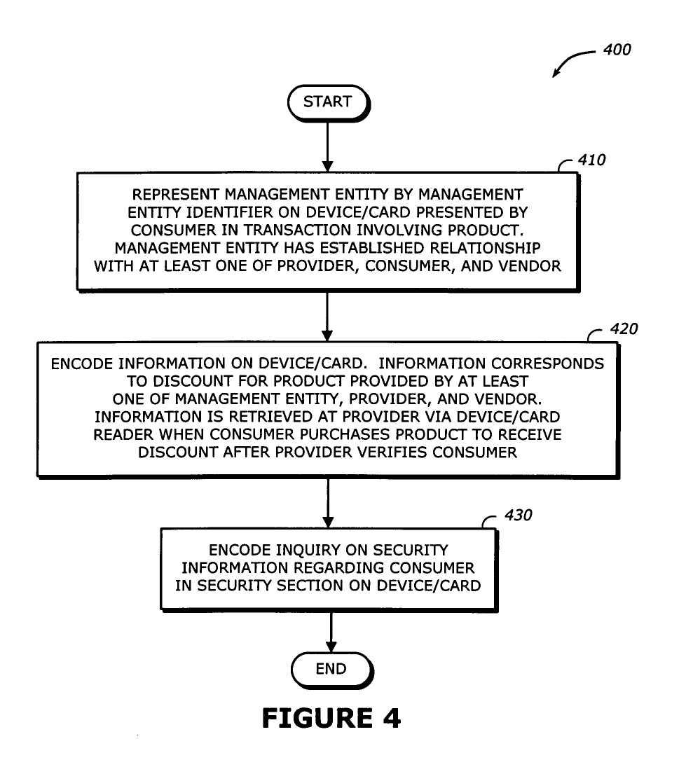

FIG. 4 is a flowchart illustrating a process 400 to create a device according to one embodiment of the invention.

Upon START, the process 400 represents a management entity by an identifier on a device presented by a consumer in a transaction involving a product (Block 410). The management entity has an established relationship with at least one of a provider, the consumer, and a vendor.

Next, the process 400 encodes information on the device (Block 420). The information corresponds to a discount for the product. The discount is provided by at least one of the management entity, the provider, and the vendor. The information is retrieved at the provider via a device reader when the consumer purchases the product to receive the discount after the provider verifies the consumer. The information includes at least one of personal identification information to identify the consumer, a value amount purchased by the consumer for a later discounted purchase, a fixed or variable discount level providing a privilege for a consumer action, and a combination of a credit or debit and a discount.

Then, the process 400 encodes an inquiry on security information regarding the consumer in a security section on the device (Block 430) and is then terminated. The security information includes at least one of secret data and biometric information. The secret data includes at least one of a password, a secret question, a security code, and a personal identification number (PIN). The secret data is used to verify the consumer.

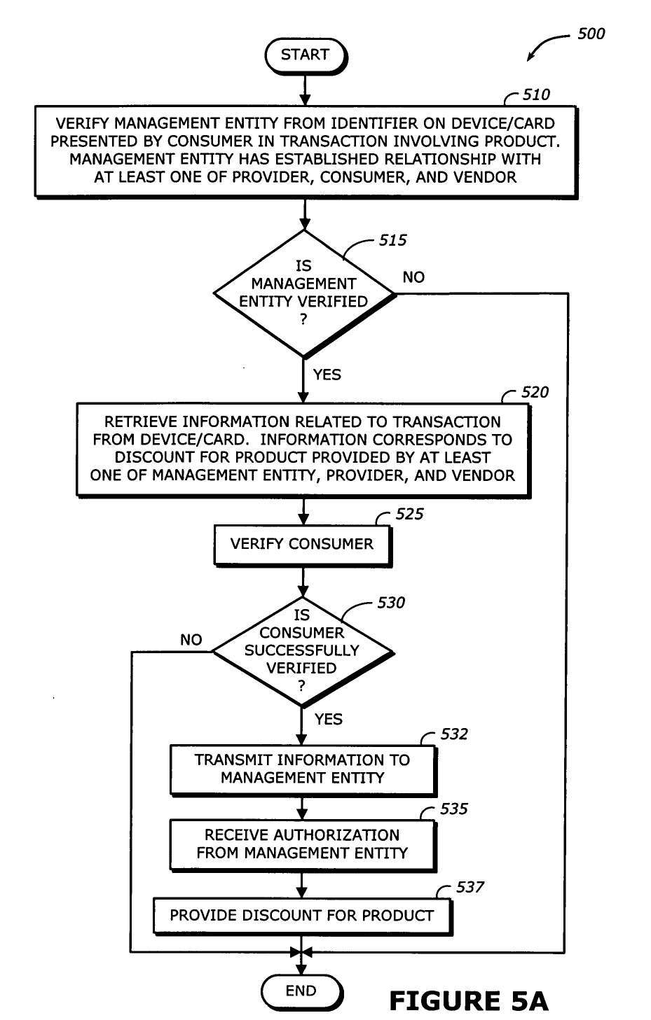

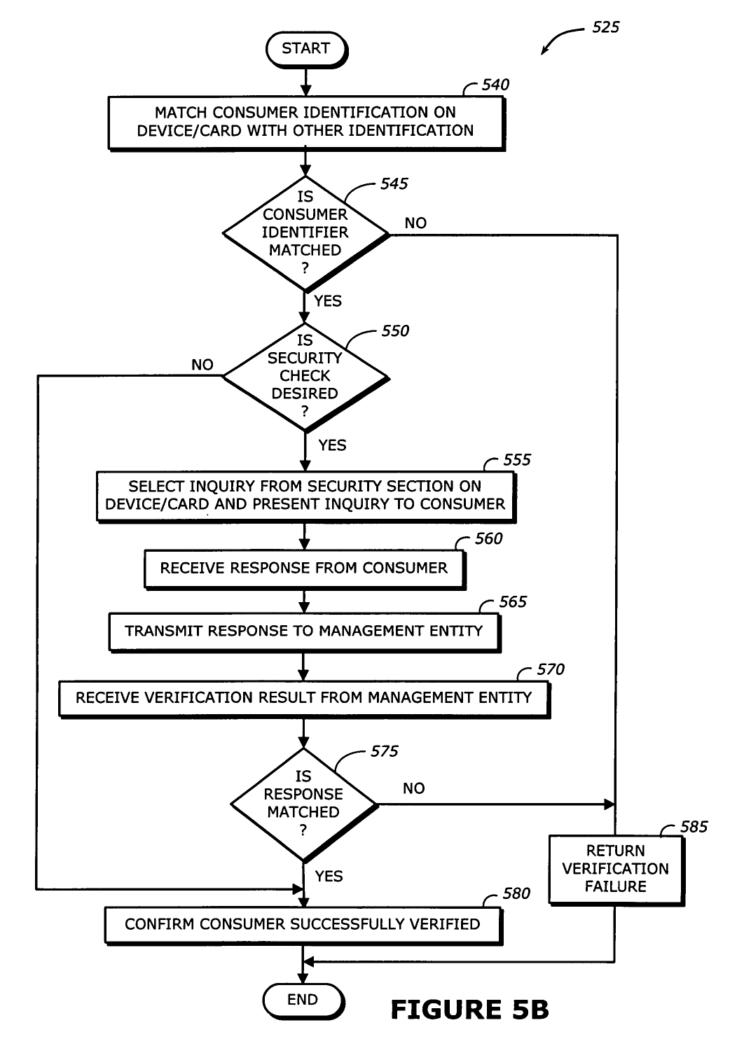

FIG. 5A is a flowchart illustrating a process 500 to process a transaction at the provider according to one embodiment of the invention.

Upon START, the process 500 verifies a management entity from an identifier on a device presented by a consumer in a transaction involving a product (Block 510). This may be performed by checking the identifier on the device to determine if it is authentic, or if the provider is a registered participant with the management entity. The management entity has an established relationship with at least one of a provider, the consumer, and a vendor. Next, the process 500 determines if the management entity is verified (Block 515). If not, the process 500 is terminated. Otherwise, the process 500 retrieves information related to the transaction from the device (Block 520). This may be performed by scanning the information on the device via a device reader. The information corresponds to a discount for the product provided by at least one of the management entity, the provider, and the vendor.

Then, the process 500 verifies the consumer (Block 525). The verification is to determine if the consumer is the legitimate holder of the device. Next, the process 500 determines if the consumer is successfully verified (Block 530). If not, the process 500 is terminated. Otherwise, the process 500 transmits the information read from the device to the management entity (Block 532). Next, the process 500 receives the authorization from the management entity (Block 535). Then, the process 500 provides the discount for the product or service (block 537) and is then terminated.

FIG. 5B is a flowchart illustrating the process 525 shown in FIG. 5 to verify the consumer at the provider according to one embodiment of the invention.

Upon START, the process 525 matches the consumer identifier on the device with other identifications (Block 540). Other identifications may include identifiers such as driver's license, passport, credit cards, etc. Next, the process 525 determines if the consumer identifier is matched (Block 545). If not, the process 525 returns a verification failure (Block 585) and is then terminated. Otherwise, the process 525 determines if a security check is desired (Block 550). If not, the process 525 goes to block 580. Otherwise, the process 525 selects an inquiry from the security section on the device and presents the inquiry to the consumer (Block 555). Next, the process 525 receives a response from the consumer (Block 560). Then, the process 525 transmits the response to the management entity (Block 565). Next, the process 525 receives a verification result from the management entity (Block 570).

Then, the process 525 determines if the verification result indicates that the response is successfully matched (Block 575). If not, the process 525 returns a verification failure (Block 585) and is then terminated. Otherwise, the process 525 confirms that the consumer is successfully verified (Block 580) and is then terminated.

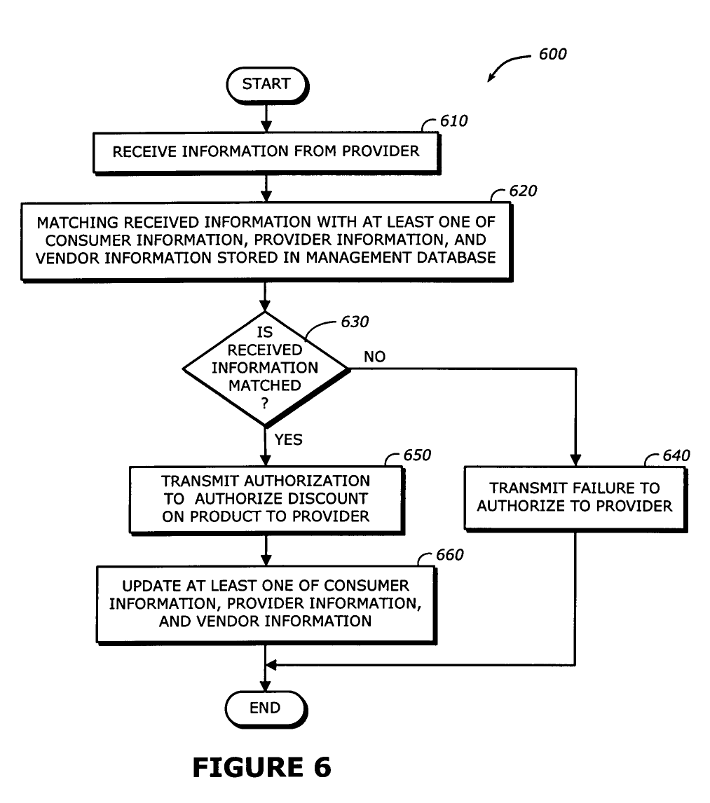

FIG. 6 is a flowchart illustrating a process 600 to process a transaction at the management entity according to one embodiment of the invention.

Upon START, the process 600 receives information from the provider (Block 610). The provider may be a retailer or a service provider. The information may include the consumer information or the response to the security inquiry. Next, the process 600 matches the received information with at least one of consumer information, provider information, and vendor information stored in the management database (Block 620). For example, the consumer information may indicate that the discount is not available because the maximum discount per household has been exceeded. Another example is the matching of the security response with the security information stored in the consumer database.

Next, the process 600 determines if the received information is matched with the information stored in the database (Block 630). If not, the process 600 transmits a failure to authorize to the provider (Block 640) and is then terminated. Otherwise, the process 600 transmits an authorization to authorize discount on product to provider (Block 650). Next, the process 600 updates at least one of the consumer information, the provider information, and the vendor information accordingly (Block 660) and is then terminated.

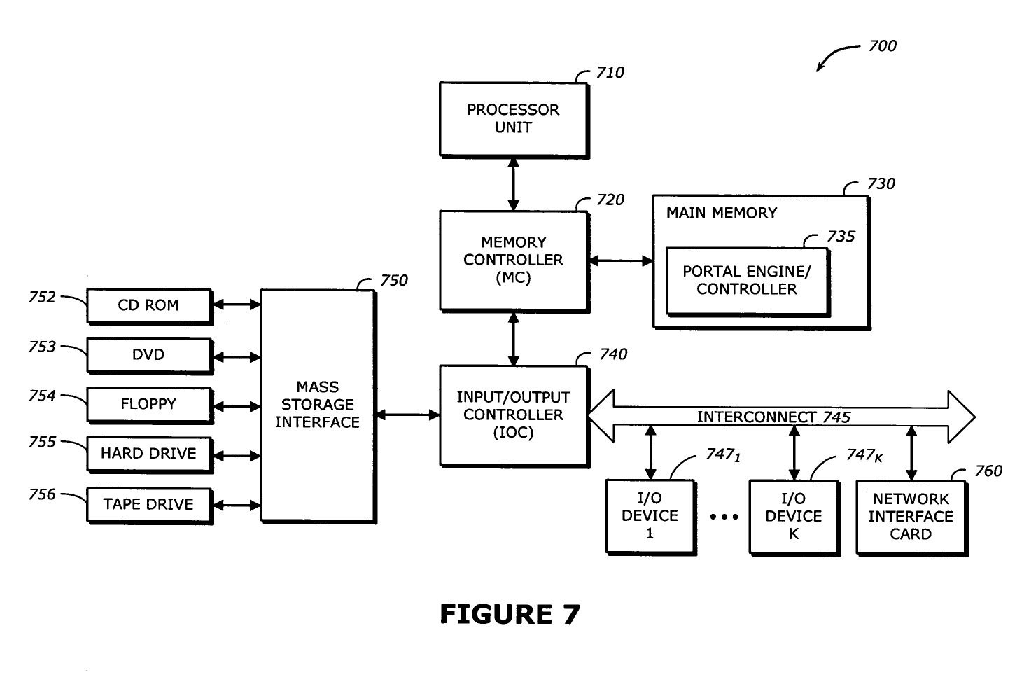

FIG. 7 is a diagram illustrating the transaction management portal engine 110 shown in FIG. 1 or the controller 330 shown in FIG. 3 according to one embodiment of the invention. The controller 230 includes a processor unit 710, a memory controller (MC) 720, a main memory 730, a graphics processor 740, an input/output controller (IOC) 750, an interconnect 755, a mass storage interface 770, and input/output (I/O devices 780₁ to 780_{K}.

The processor unit 710 represents a central processing unit of any type of architecture, such as processors using hyper threading, security, network, digital media technologies, single-core processors, multi-core processors, embedded processors, mobile processors, micro-controllers, digital signal processors, superscalar computers, vector processors, single instruction multiple data (SIMD) computers, complex instruction set computers (CISC), reduced instruction set computers (RISC), very long instruction word (VLIW), or hybrid architecture.

The MC 720 provides control and configuration of memory and input/output devices such as the main memory 730 and the IOC 740. The MC 720 may be integrated into a chipset that integrates multiple functionalities such as graphics, media, isolated execution mode, host-to-peripheral bus interface, memory control, power management, etc. The MC 720 or the memory controller functionality in the MCH 720 may be integrated in the processor unit 710. In some embodiments, the memory controller, either internal or external to the processor unit 710, may work for all cores or processors in the processor unit 710. In other embodiments, it may include different portions that may work separately for different cores or processors in the processor unit 710.

The main memory 730 stores system code and data. The main memory 730 is typically implemented with dynamic random access memory (DRAM), static random access memory (SRAM), or any other types of memories including those that do not need to be refreshed. The main memory 730 may include multiple channels of memory devices such as DRAMs. The main memory 730 may include a control module or a portal engine 735. The control module or the portal engine 735 includes program instructions and data to perform control or portal functions. These functions may include the functions performed by the portal engine 110 (FIG. 1) or the controller 330 (FIG. 3).

The graphics processor 740 is any processor that provides graphics functionalities. The graphics processor 740 may also be integrated into the MC 720 to form a Graphics and Memory Controller (GMC). The graphics processor 740 may be a graphics card such as the Graphics Performance Accelerator (AGP) card, interfaced to the MC 720 via a graphics port such as the Accelerated Graphics Port (AGP) or a peripheral component interconnect (PCI) Express interconnect. The graphics processor 740 provides interface to an external display device such as standard progressive scan monitor, television (TV)-out device, and Transition Minimized Differential Signaling (TMDS) controller.

The IOC 750 has a number of functionalities that are designed to support I/O functions. The IOC 750 may also be integrated into a chipset together or separate from the MC 720 to perform I/O functions. The IOC 750 may include a number of interface and I/O functions such as peripheral component interconnect (PCI) bus interface, processor interface, interrupt controller, direct memory access (DMA) controller, power management logic, timer, system management bus (SMBus), universal serial bus (USB) interface, mass storage interface, low pin count (LPC) interface, wireless interconnect, direct media interface (DMI), etc.

The interconnect 755 provides interface to peripheral devices. The interconnect 855 may be point-to-point or connected to multiple devices. For clarity, not all interconnects are shown. It is contemplated that the interconnect 755 may include any interconnect or bus such as Peripheral Component Interconnect (PCI), PCI Express, Universal Serial Bus (USB), Small Computer System Interface (SCSI), serial SCSI, and Direct Media Interface (DMI), etc.

The mass storage interface 770 interfaces to mass storage devices to store archive information such as code, programs, files, data, and applications. The mass storage interface may include SCSI, serial SCSI, Advanced Technology Attachment (ATA) (parallel and/or serial), Integrated Drive Electronics (IDE), enhanced IDE, ATA Packet Interface (ATAPI), etc. The mass storage device may include compact disk (CD) read-only memory (ROM) 772, digital versatile disc (DVD) 773, floppy drive 774, hard drive 775, tape drive 776, and any other magnetic or optic storage devices. The mass storage device provides a mechanism to read machine-accessible media.

The I/O devices 780₁ to 780_{K} may include any I/O devices to perform I/O functions. Examples of I/O devices 780₁ to 780_{K} include controller for input devices (e.g., keyboard, mouse, trackball, pointing device, and remote control unit), media card (e.g., audio, video, and graphic), network card, and any other peripheral controllers.

Elements of one embodiment of the invention may be implemented by hardware, firmware, software or any combination thereof. The term hardware generally refers to an element having a physical structure such as electronic, electromagnetic, optical, electro-optical, mechanical, electromechanical parts, etc. The term software generally refers to a logical structure, a method, a procedure, a program, a routine, a process, an algorithm, a formula, a function, an expression, etc. The term firmware generally refers to a logical structure, a method, a procedure, a program, a routine, a process, an algorithm, a formula, a function, an expression, etc., that is implemented or embodied in a hardware structure (e.g., flash memory, ROM, EPROM). Examples of firmware may include microcode, writable control store, micro-programmed structure. When implemented in software or firmware, the elements of an embodiment of the present invention are essentially the code segments to perform the necessary tasks. The software/firmware may include the actual code to carry out the operations described in one embodiment of the invention, or code that emulates or simulates the operations. The program or code segments can be stored in a processor or machine accessible medium or transmitted by a computer data signal embodied in a carrier wave, or a signal modulated by a carrier, over a transmission medium. The “processor readable or accessible medium” or “machine readable or accessible medium” may include any medium that can store, transmit, or transfer information. Examples of the processor readable or machine accessible medium include an electronic circuit, a semiconductor memory device, a read only memory (ROM), a flash memory, an erasable programmable ROM (EPROM), a floppy diskette, a compact disk (CD) ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc. The machine accessible medium may be embodied in an article of manufacture. The machine accessible medium may include information or data that, when accessed by a machine, cause the machine to perform the operations or actions described above. The machine accessible medium may also include program code embedded therein. The program code may include machine readable code to perform the operations described above. The term “information” or “data” here refers to any type of information that is encoded for machine-readable purposes. Therefore, it may include program, code, data, file, etc.

All or part of an embodiment of the invention may be implemented by hardware, software, or firmware, or any combination thereof. The hardware, software, or firmware element may have several modules coupled to one another. A hardware module is coupled to another module by mechanical, electrical, optical, electromagnetic or any physical connections. A software module is coupled to another module by a function, procedure, method, subprogram, or subroutine call, a jump, a link, a parameter, variable, and argument passing, a function return, etc. A software module is coupled to another module to receive variables, parameters, arguments, pointers, etc. and/or to generate or pass results, updated variables, pointers, etc. A firmware module is coupled to another module by any combination of hardware and software coupling methods above. A hardware, software, or firmware module may be coupled to any one of another hardware, software, or firmware module. A module may also be a software driver or interface to interact with the operating system running on the platform. A module may also be a hardware driver to configure, set up, initialize, send and receive data to and from a hardware device. An apparatus may include any combination of hardware, software, and firmware modules.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting.

What is claimed is:

1. A device comprising:
an identifier to represent a management entity, the management entity having an established relationship with at least one of a provider, a consumer, and a vendor; and
a medium encoded with an information section to contain information related a transaction conducted by the consumer at the provider, the transaction involving a product, the information corresponding to a discount for the product provided by at least one of the management entity, the provider, and the vendor, the information being retrieved at the provider via a device reader when the consumer purchases the product to receive the discount after the provider verifies the consumer.

2. The device of claim 1 wherein the provider is one of a service provider and a retailer.

3. The device of claim 1 wherein the information comprises at least one of personal identification information to identify the consumer, a value amount purchased by the consumer for a later discounted purchase, a fixed or variable discount level providing a privilege for a consumer action, and a combination of a credit or debit and a discount coupon.

4. The device of claim 1 further comprising:
a security section to contain an inquiry on security information regarding the consumer.

5. The device of claim 4 wherein the security information comprises at least one of secret data and biometric information.

6. The device of claim 5 wherein the secret data comprises at least one of a password, a secret question, a security code, and a personal identification number (PIN), the secret data being used to verify the consumer.

7. A method comprising:
representing a management entity by an identifier on a device presented by a consumer in a transaction involving a product, the management entity having an established relationship with at least one of a provider, the consumer, and a vendor; and
encoding information on the device, the information corresponding to a discount for the product provided by at least one of the management entity, the provider, and the vendor, the information being retrieved at the provider via a device reader when the consumer purchases the product to receive the discount after the provider verifies the consumer.

8. The method of claim 7 wherein the provider is one of a service provider and a retailer.

9. The method of claim 7 wherein the information comprises at least one of personal identification information to identify the consumer, a value amount purchased by the consumer for a later discounted purchase, a fixed or variable discount level providing a privilege for a consumer action, and a combination of a credit or debit and a discount coupon.

10. The method of claim 7 further comprising:
encoding an inquiry on security information regarding the consumer in a security section on the device.

11. The method of claim 10 wherein the security information comprises at least one of secret data and biometric information.

12. The method of claim 11 wherein the secret data comprises at least one of a password, a secret question, a security code, and a personal identification number (PIN), the secret data being used to verify the consumer.

13. A processing unit comprising:
a device reader to read a device presented by a consumer in a transaction involving a product at a provider, the device containing an identifier to represent a management entity and information related to the transaction, the management entity having an established relationship with at least one of the provider, the consumer, and a vendor, the information corresponding to a discount for the product provided by at least one of the management entity, the provider, and the vendor; and
a communication interface coupled to the device reader to transmit the information to the management entity and receive discount information on the transaction from the management entity, the discount information being used to give the discount to the consumer after the consumer is verified.

14. The processing unit of claim 13 wherein the provider is one of a service provider and a retailer.

15. The processing unit of claim 13 wherein the information comprises at least one of personal identification information to identify the consumer, a value amount purchased by the consumer for a later discounted purchase, a fixed or variable discount level providing a privilege for a consumer action, and a combination of a credit or debit and a discount.

16. The processing unit of claim 13 wherein the device reader reads a security section containing an inquiry on security information regarding the consumer.

17. The processing unit of claim 16 wherein the security information comprises at least one of secret data and biometric information.

18. The processing unit of claim 17 wherein the secret data comprises at least one of a password, a secret question, a security code, and a personal identification number (PIN), the secret data being used to verify the consumer.

19. A method comprising:
verifying a management entity from an identifier on a device presented by a consumer in a transaction involving a product, the management entity having an established relationship with at least one of a provider, the consumer, and a vendor;
retrieving information related to the transaction from the device, the information corresponding to a discount for the product provided by at least one of the management entity, the provider, and the vendor;
verifying the consumer; and
providing the discount for the product after the consumer is verified.

20. The method of claim 19 wherein the provider is one of a service provider and a retailer.

21. The method of claim 19 wherein the information comprises at least one of personal identification information to identify the consumer, a value amount purchased by the consumer for a later discounted purchase, a fixed or variable discount level providing a privilege for a consumer action, and a combination of a credit or debit and a discount.

22. The method of claim 21 wherein the information further comprises at least an inquiry regarding one of secret data and biometric information.

23. The method of claim 22 wherein the secret data comprises at least one of a password, a secret question, a security code, and a personal identification number (PIN), the secret data being used to verify the consumer.

24. The method of claim 23 wherein verifying comprises:
receiving a response from the consumer responsive to at least one of the secret data and the biometric information; and
matching the response to the at least one of the secret data and the biometric information.
